(19) United States
(12) Patent Application Publication
(10) Pub. No.: US 2021/0107784 A1
(43) Pub. Date: Apr. 15, 2021

(54) Ergonomic Horse Riding Stirrup

(71) Applicant: Nadiya M. Tkachuk, Columbus, NC (US)

(72) Inventor: Nadiya M. Tkachuk, Columbus, NC (US)

(21) Appl. No.: 16/600,543

(22) Filed: Oct. 13, 2019

(51) Int. Cl. B68C 3/00

(52) U.S. Cl. CPC B68C 3/00; B68C 3/025; B68C 2003/0041

(57) ABSTRACT

A horse rider's weight is at least partially supported by pair of stirrups suspended from the sides of a riding saddle. This weight is concentrated at the points of contact between the rider's feet and the stirrups, contributing over time to discomfort, fatigue, and injury. Ergonomic riding stirrups distribute rider's weight over a wider contact area, while promoting a natural foot shape and position. This effect is conveyed by a stirrup footrest shape that is complementary to a natural foot shape during a riding activity.

### CROSS REFERENCE TO RELATED APPLICATIONS

The present application is based on U.S. provisional application No. 62/385,921, filed on Sep. 9, 2016, the contents of which are hereby incorporated by reference.

### FIELD OF THE INVENTION

The invention relates to sporting goods, specifically, to horse riding equipment.

### BACKGROUND OF THE INVENTION

Horse riding stirrups, also referred to as stirrup irons, are suspended from each side of a riding saddle to provide a rest for rider's feet. A portion of rider's weight is continuously supported by the small area of contact between rider's feet and the stirrups. Horse riding and, especially, horse jumping may require a rider to maintain a so-called two-point position with the rider's full weight and substantial dynamic loads concentrated in those few square inches of contact. This area is further reduced when rider's foot rocks and presses against the edge of the stirrup platform. A ride may extend for an hour or more and many professional and active amateur riders may ride several horses a day.

This concentrated pressure can have severe impact on person's feet, including impeded circulation leading to reduced foot sensitivity and mobility, as well as foot and ankle pain during and following riding activity. This negative experience detracts from the enjoyment of recreational riding and from performance in competitions. Permanent issues may develop over time, including arthritis, that may affect the person's wellbeing outside of the riding arena. These issues are not adequately addressed by riding boots as such boots are typically designed with thin and flexible soles for closer contact and greater sensitivity.

Additionally, maintaining proper position of feet in the stirrups is a commonly experienced challenge for horse riders. A rider's foot may slip out of or deeper into the stirrup, interrupting the normal flow of riding and contributing to the risk of a riding accident. The physical and mental effort of keeping hold of the stirrups is a distraction from the more relevant aspects of riding activity.

### SUMMARY OF THE INVENTION

The present invention describes an ergonomic stirrup design that seeks to address the above issues by providing a larger area over which the load is distributed and maintaining said area over a range of foot positions and movements.

In this disclosure, “length” refers to a measurement along a rider's foot and “width” refers to measurement across a rider's foot. “Front”, “back”, “inside”, and “outside” are defined with respect to the direction of a rider's foot. When rider's feet are referenced, it should be understood in the context of a horse riding activity, including the use of customary footwear.

One aspect of an ergonomic horse riding stirrup invention is a longer footrest compared to a typical English stirrup footrest. A second aspect of the invention is a footrest with a concave shape to cradle the ball of the foot. A desired shape can be created, for example, by front and back platform surfaces forming an angle or by a smooth front-to-back curvature.

This shape can further be created or enhanced by deformation of an elastic layer covering the top of the stirrup footrest, a third aspect of the invention. The elastic layer can be pre-shaped, or it may possess sufficient thickness and elasticity to mold to the sole of a rider's boot under normal load. The elastic layer also provides additional shock absorption during riding activities.

A fourth aspect of the invention is a stirrup pad with a top surface having a shape and properties described above. The pad can be permanently attached to a stirrup frame, or it can be a removable pad to be used with stirrup frames designed for interchangeable pads. A set of several such pads may provide a range of characteristics optimized, for example, for competition, horse training, and pleasure riding.

A fifth aspect of the invention is a stirrup footrest with an opening that cradles the ball of a rider's foot. The opening may optionally hold an elastic pad or be filled with elastic material.

A sixth aspect of the invention is a stirrup footrest with a dynamically adjustable shape. For example, the stirrup footrest may form a hinge with its axis affixed to the two opposite ends of the stirrup arch. The shape of the footrest can be adjusted by closing or opening the hinge to accommodate the shape of the rider's sole or personal preference.

In addition to distributing rider's weight and dynamic load over a wider area, a shaped stirrup footrest described above helps maintain a fixed position of rider's foot with respect to the stirrup. An extended contact area further counteracts slippage with increased friction. The invention thus reduces the probability of a rider's foot sliding forward into the stirrup and getting caught in the stirrup in the event of an accident. The ability to maintain a secure and confident stance in the stirrups will allow a rider to fully concentrate on better control of a horse and thus further improve safety of a riding activity.

### BRIEF DESCRIPTION OF THE DRAWINGS

FIG. 1 is a 3-D rendering of a preferred embodiment of an ergonomic riding stirrup.

FIGS. 2A-D are schematic drawings of vertical front-to-back cross sections of solid footrests of various shapes.

FIGS. 3A-C are schematic drawings of vertical front-to-back cross sections of footrests of various shapes comprising solid bases and elastic pads.

FIGS. 4A-E are schematic drawings of vertical front-to-back cross sections of footrests of various shapes comprising solid bases with openings and elastic pads.

FIGS. 5A-C are schematic drawings of vertical front-to-back cross sections of adjustable footrests.

FIGS. 6A-C is a 3-D rendering of another preferred embodiment of an ergonomic riding stirrup.

### DETAILED DESCRIPTION OF THE INVENTION

The following embodiments are discussed as non-limiting cases. Other embodiments of the invention should be apparent to those skilled in the art.

In one embodiment, an ergonomic stirrup 100 comprises an arch 101 and footrest 102 supported by the arch. The footrest length may be between 2 inches and 5 inches, or about 3 inches, or about 1.5 times the length of an average English riding stirrup footrest.

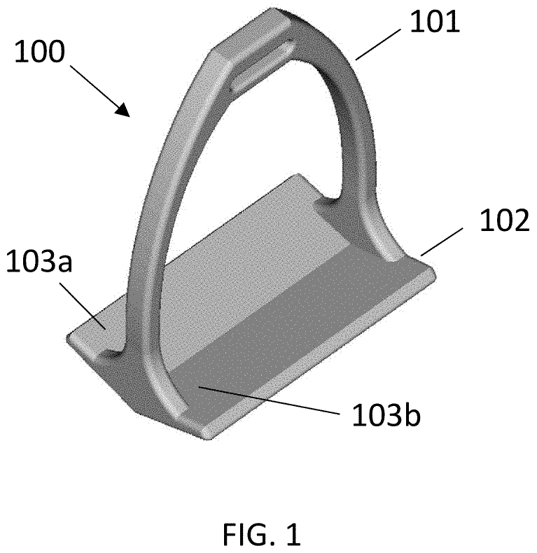

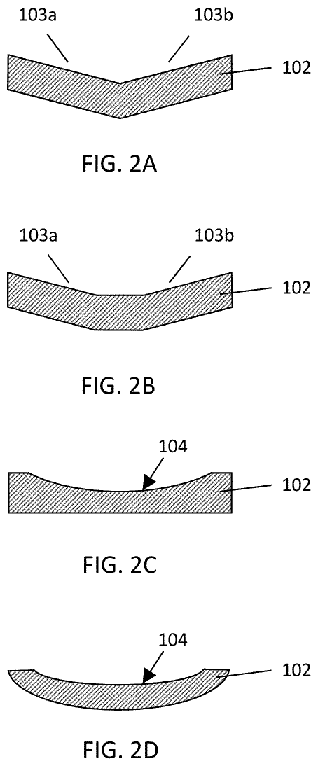

In one embodiment, as illustrated in FIG. 1, the footrest comprises two substantially flat platforms 103a and 103b, joined at an angle. The angle may be, for example, between 135 degrees and 175 degrees. The two platforms may have substantially the same length, or they may have different lengths. For example, the front platform may be longer than the back platform. A junction between the two platforms may comprise one of a corner (FIG. 2A), a flat area (FIG. 2B), a rounded area, and an opening.

In another embodiment, a top surface of a footrest has a curved shape 104, wherein a low point of the curved shape is near a middle of the footrest (FIGS. 2C, 2D). In one embodiment, the top surface of a footrest is curved in the front-to-back direction and the curved shape approximates a segment of a circle or another conic section. The top surface of a footrest may be further curved in the inside-to-outside direction and the curvature in the front-to-back direction may be larger than the curvature in the inside-to-outside direction. In one embodiment, the top surface of a footrest is curved to approximate the shape of a rider's foot in a riding position, with the low point of the curve corresponding to the ball of the foot.

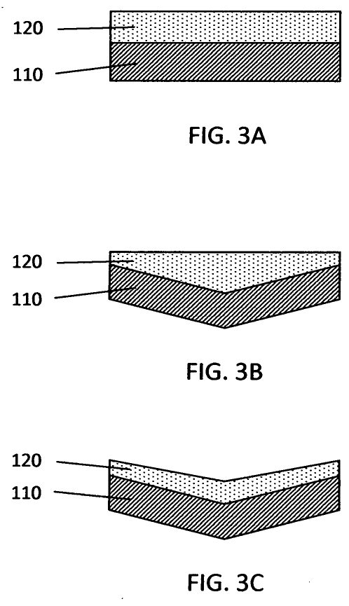

In another embodiment, a top surface of a footrest comprises an elastic material that deforms under the weight of a rider to approximate the shape of the rider's foot in a riding position. The elastic layer may deform under rider's weight, for example, by between 0.1 of an inch and 1 inch, or by about 0.5 of an inch. In one embodiment, as illustrated in FIGS. 3A-C, the elastic material is arranged in a deformable layer 120 that overlays a solid footrest base 110. At least one of the thickness and the elasticity of the deformable layer is selected to achieve a desired degree of deformation of the layer. The top surface of the elastic layer may be flat (FIGS. 3A, 3B), or it may be curved (FIG. 3C) as described in reference to other embodiments above. The elastic layer may possess elastic memory to at least temporarily retain its shape once deformed. The solid base may further be flat (FIG. 3A), or it may be curved (FIGS. 3B, 3C) as described in reference to other embodiments above. A curved solid base may help achieve a desired shape using a thinner deformable layer. The deformable layer may be permanently attached to the solid base, or it may be attached as a removable and replaceable pad.

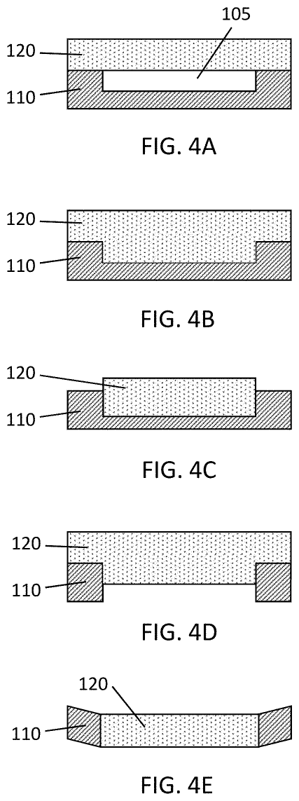

In a related embodiment, a solid footrest base 110 comprises an opening 105 and an elastic material is arranged in a deformable layer 120 that overlays the opening. The opening may be a blind (FIGS. 4A-C) or a through opening (FIGS. 4D, 4E). The elastic material may further at least partially fill the opening (FIGS. 4B-E). This design has several desirable features. Without a solid backing, a desired degree of deformation may be achieved with a firmer and, consequently, more durable elastic material. The deformable layer can be made thinner and the overall height of the footrest can also be reduced. The elastic material may be furnished as a removable pad and the footrest may incorporate means of securing said pad, such as flanges or set screws.

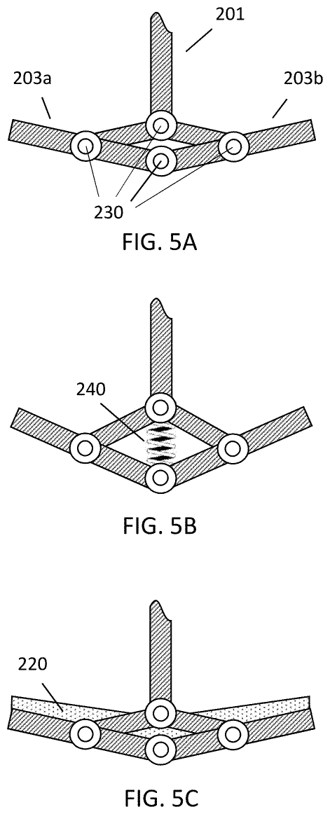

In one embodiment, the footrest comprises two substantially flat platforms 203a and 203b, joined at an adjustable angle (FIGS. 5A-C). The angle may be adjustable, for example, between 135 degrees and 180 degrees. In this embodiment, a junction between the two platforms may comprise a hinge mechanism 230. A junction between the frame arch 201 and the footrest may further comprise at least one hinge mechanism. An at least one hinge mechanism in this embodiment may include a locking mechanism to lock the angle between the platforms in between adjustments. An adjustment screw may be incorporated into the design to control the angle.

A related embodiment may incorporate a spring-loaded mechanism 240 acting to maintain a flat footrest when no weight is applied and changing its angle dynamically in response to foot position and load. Hard stops may be incorporated into the stirrup arch to limit angle variation to a predetermined range. An elastic layer 220 may be incorporated into this embodiment (FIG. 5C).

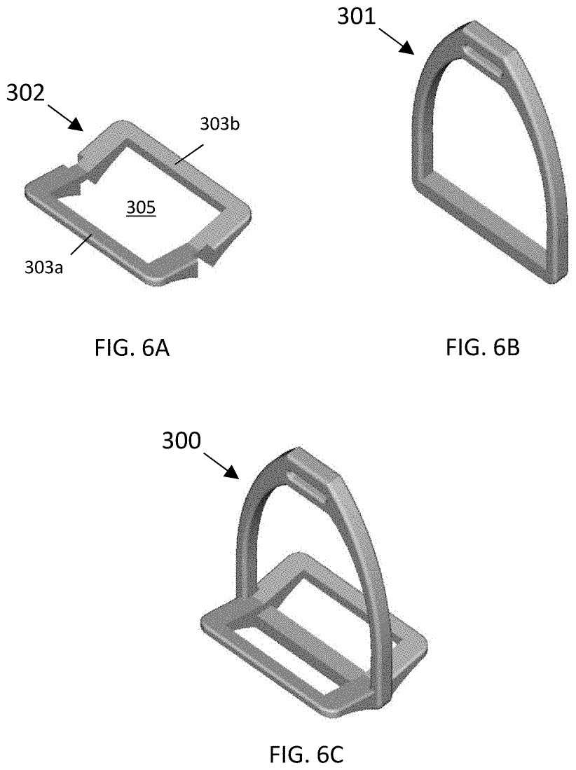

In yet another embodiment, a solid footrest comprises an opening that allows the sole of a rider's boot to deform into a shape approximating the shape of the rider's foot in a riding position. Such a footrest 302, as illustrated in FIG. 6A, comprises a front support bar 303a, a back support bar 303b, and an opening 305 in between, which is wide enough to allow for such a deformation. The opening 305 cradles the ball of the foot, partially relieving the pressure that would otherwise be concentrated in this area. At least one of the front and back support bars may be angled down toward the center of the stirrup. FIGS. 6A-C further shows how a stirrup arch 301 and a footrest 302 may be furnished as separate pieces for final assembly into a stirrup 300. The opening in the footrest may be filled with elastic material.

The invention illustrated in the above embodiments may be combined with other features designed to enhance rider's performance, safety, and comfort. Such features may include, for example, surface materials, textures and patterns designed to promote friction between the top surface of a footrest and a rider's foot. Other enhancements may include various safety features, such as automatic release mechanisms and breakaway designs for the outer arm of a stirrup arch.

A stirrup may be fabricated, without limitation, of a metal or an alloy, such as stainless steel, aluminum, titanium; a plastic, a metal reinforced plastic, a composite material, such as fiberglass, carbon fiber reinforced polymer; or another material or combination of materials known to those skilled in the art. A stirrup pad may be fabricated, without limitation, of a variety of elastomer materials.

What is claimed is:

1. An ergonomic horse riding stirrup comprising an arch and a footrest supported by the arch, wherein the top surface of the footrest has a shape that is at least partially complementary to a shape of a rider's foot.

2. The stirrup of claim 1, wherein the top surface of the footrest comprises a first surface and a second surface, wherein said first surface and second surface form an angle.

3. The stirrup of claim 2, further comprising an opening between a first surface and a second surface.

4. The stirrup of claim 2, wherein said angle is adjustable.

5. The stirrup of claim 1, wherein the top surface of the footrest is concave with respect to at least one dimension.

6. The stirrup of claim 1; wherein the footrest comprises a first support bar, a second support bar, and an opening between said first and second support bars.

7. An ergonomic stirrup comprising an arch and a footrest supported by the arch, wherein the top surface of the footrest is deformable into a shape that is at least partially complementary to a shape of a rider's foot.

8. The stirrup of claim 7, wherein the top surface of the footrest is deformable into a concave shape under rider's weight.

9. The stirrup of claim 7, wherein the footrest comprises a solid base and a deformable pad disposed over the solid base.

10. The stirrup of claim 9, wherein the top surface of the solid base has a shape that is at least partially complementary to a shape of a rider's foot.

11. The stirrup of claim 9, wherein the footrest comprises a solid base having an opening, and wherein a deformable pad is disposed at least one of in and over the opening.

12. The stirrup of claim 9, wherein the deformable pad is at least one of removable and replaceable.

13. An ergonomic stirrup pad comprising a top surface deformable into a shape that is at least partially complementary to a shape of a rider's foot and further comprising means of attachment to a stirrup footrest.

14. The stirrup pad of claim 13, wherein a top surface of the pad is deformable into a concave shape under rider's weight.

15. A method of relieving pressure on rider's foot comprising attaching a pad to a footrest of a horse riding stirrup, wherein a top surface of the pad is deformable into a shape that is at least partially complementary to a shape of a rider's foot.

16. The method of claim 15, wherein a top surface of the pad is deformable into a concave shape under rider's weight.
